(19) United States
(12) Patent Application Publication
(10) Pub. No.: US 2019/0070568 A1
(43) Pub. Date: Mar. 7, 2019

(54) PERMEATION MEMBRANE AND METHOD FOR PRODUCING A PERMEATION MEMBRANE

(71) Applicants: Fraunhofer-Gesellschaft zur Foerderung der angewandten Forschung e.V., Munich (DE); Friedrich-Alexander-Universitaet Erlangen-Nuernberg, Erlangen (DE)

(72) Inventors: Hannes RICHTER, Hermsdorf (DE); Adrian SIMON, Bad Klosterlausnitz (DE); Yvonne JUETTKE, Jena (DE); Wilhelm SCHWIEGER, Spardorf (DE); Marion SCHUELEIN, Wassertruedingen (DE); Dirk LUEDKE, Crailsheim (DE); Benjamin REIF, Neustadt an der Aisch (DE)

(21) Appl. No.: 16/081,070

(22) PCT Filed: Feb. 28, 2017
(86) PCT No.: PCT/DE2017/100156

§ 371 Date: Aug. 30, 2018

(30) Foreign Application Priority Data
Mar. 1, 2016 (DE) 10 2016 103 645.5

(51) Int. Cl. B01D 71/02

(52) U.S. Cl. CPC B01D 71/028; B01D 65/108

(57) ABSTRACT

Disclosed is a permeation membrane and a method for producing a permeation membrane. The permeation membrane can be used in particular in the field of membrane-based material separations. The permeation membrane is composed of an inorganic semi-permeable substance in which an additional substance is incorporated in some locations such that existing intermediate spaces in the semi-permeable substance are at least partly filled by the additional substance and thus only the intermediate spaces are blocked for a permeating species.

The invention relates to a method for producing a permeation membrane. The permeation membrane can be used in the field of membrane-based substance separation, but in particular for the separation of water from gas streams.

Ideal zeolite membranes composed of microporous, crystalline aluminosilicates having an open three-dimensional lattice structure of pores and cavities in molecular dimensions and without intercrystalline pores can be of great importance in the petrochemical industry and for the production of fine chemicals. As various reviews of zeolite membranes have now shown, such membranes have an enormous potential for practical application in industrial gas separation processes [e.g. E. E. McLeary, J. C. Jansen, F. Kapteijn, Zeolite based films, membranes and membrane reactors: Progress and prospects, Microporous Mesoporous Mater., 90 (2006) 198-220]. Recently, numerous reports on the development of zeolite membranes with an MFI-framework have been published, as these zeolite membranes are relatively simple to produce compared to other types [M. Noack, M. Schneider, A. Dittmar, G. Georgi, J. Caro, The change of the unit cell dimension of different zeolite types by heating and its influence on supported membrane layers, Microporous Mesoporous Mater., 117 (2009) 10-21]. Other zeolite membranes composed of LTA, BEA, FAU, MOR, FER and CHA frameworks have also been intensively studied due to their considerable application potential. Despite the impressive research conducted in the field of zeolite membranes, these membranes have not yet been applied in large-scale industrial gas separation processes, but there have been successes in the industrial-scale use of zeolite membranes in the field of membrane-based pervaporation methods [J. Caro, M. Noack, Zeolite membranes—Recent developments and progress, Microporous Mesoporous Mater. 2008, pp. 215-233].

An ideal zeolite membrane requires an almost perfectly dense zeolite layer on a carrier, which imparts mechanical stability to the system, but without affecting separation or substance transport. The thickness and uniformity of the polycrystalline zeolite layer directly affect membrane performance with respect to flow and selectivity. In general, the thickness and uniformity of the zeolite layer are controlled by crystal size and the orientation of the crystals relative to the membrane layer. In order to obtain a membrane with high productivity and selectivity, an ultrathin membrane layer with negligible intercrystalline defects is required [E. Sjoberg, L. Sandstrom, O. G. W. Ohrman, J. Hedlund, Separation of CO₂ from black liquor derived syngas using an MFI membrane, J. Membr. Sci., 443 (2013) 131-137].

The intercrystalline pores (cracks and defects) are presumably formed by the high surface load of the individual crystals and also by the thermal expansion of individual crystals during the thermal treatment. These intercrystalline pores are referred to as defects and lead in the membrane separation process to non-selective transport through the membrane structure. As the zeolite membrane is composed of coalesced polycrystalline structures, there are problems with inherent defects that are caused by expansion or shrinkage of the crystals during the thermal treatment cycles (heating/cooling) of the calcination or activation processes of the membrane materials [M. Noack, M. Schneider, A. Dittmar, G. Georgi, J. Caro, The change of the unit cell dimension of different zeolite types by heating and its influence on supported membrane layers, Microporous Mesoporous Mater., 117 (2009) 10-21], as well as by the surface loading of the crystals of Al-rich zeolites referred to by the same term, whereby coalescing of the individual crystals is prevented (defects) [M. Noack, P. Kölsch, A. Dittmar, M. Stöhr, G. Georgi, M. Schneider, U. Dingerdissen, A. Feldhoff, J. Caro, Proof of the 155 concept for LTA and FAU membranes and their characterization by extended gas permeation studies, Microporous Mesoporous Mater., 102 (2007) 1-20]. In order to produce an ideal zeolite membrane, in which transport takes place only via the regular intracrystalline micropores, the intercrystalline defects would have to be prevented. Many methods have been used in an attempt to overcome this problem, such as e.g. modification of the synthesis route, repeated synthesis, or various aftertreatments.

High-quality membranes have been obtained by microwave-assisted synthesis [X. Xu, Y. Bao, C. Song, W. Yang, J. Liu, L. Lin, Microwave-assisted hydrothermal synthesis of hydroxy-sodalite zeolite membrane, Microporous Mesoporous Mater., 75 (2004) 173-181].

Large defects have generally been observed in membranes composed of large crystals. By using very small seed particles and synthesis conditions with low crystal growth, one obtains thin membranes of small crystal size that show only a small defect size [J. Hedlund, J. Sterte, M. Anthonis, A.-J. Bons, B. Carstensen, N. Corcoran, D. Cox, H. Deckman, W. D. Gijnst, P.-P. de Moor, F. Lai, J. McHenry, W. Mortier, J. Reinoso, J. Peters, High-flux MFI membranes, Microporous and Mesoporous Membranes 2002, pp. 179-189].

High-quality membranes with negligible intracrystalline pores have been observed for several zeolite types produced by multiple in situ crystallization [A. Avahle, D. Kaya, G. T. P. Mabande, T. Selvam, W. Schwieger, T. Stief, R. Dittmeyer, Defect-free zeolite membranes of the type BEA for organic vapour separation and membrane reactor applications., Stud. Surf. Sci. Catal., 174 A (2008) 699-672].

Using an extremely low heating rate during thermal treatment, the quality of the membranes was improved somewhat, with intracrystalline macropores being reduced to the size range of mesopores [M. Noack, M. Schneider, A. Dittmar, G. Georgi, J. Caro, The change of the unit cell dimension of different zeolite types by heating and its influence on supported membrane layers, Microporous Mesoporous Mater., 117 (2009) 10-21 ].

By applying a subsequent coating of a polyimide resin precursor by spin coating, it was possible to increase the selectivity of zeolite membranes for isomer separation of xylol [Deckmann, H (US); Corcoran, E (US); McHenry, J (US); Lai, W (US); Czarnetzki, L (NL); Wales, W (US); A zeolite containing composition with a selectivity enhancing coating, WO 1996/001686, US 1995/008513, 10 Jul. 1995].

A reduction in permeation for water was also achieved by subsequent coating of hydrophobic zeolite layers (silicalite) with (hydrophobic) silicone, so that a preferred hydrogen permeation was found in the separation of hydrogen/water mixtures [EP 1118378 A1]. In said patent document, this principle is expanded theoretically to also include other membranes of a wide variety of zeolites and also to include carbon as a coating material, wherein a higher permeation for hydrogen than for water is always postulated.

The object of the invention is to produce or provide a permeation membrane that allows only substances to pass for which an ideal permeation membrane, i.e. without inherently occurring defects, is designed. More particularly, this is also to apply to the permeation of very small water and hydrogen molecules and to the separation thereof in favor of the water molecule.

According to the invention, this object is achieved by a permeation membrane that is composed of an inorganic, semipermeable substance into which a further substance is incorporated at certain points such that existing intermediate spaces in the semipermeable substance are at least partially filled by the further substance, and thus only the intermediate spaces are blocked for a permeating species. In this case, the further substance is advantageously an x-ray amorphous carbon, and the semipermeable substance is a crystalline substance with a zeolite structure.

The crystalline substance can advantageously be selected from the group of aluminosilicates, aluminophosphates, silicon aluminophosphates or metal-organic frameworks.

The crystalline substances with a zeolite structure are representative of the structures SOD, LTA, ERI, CHA, MFI and FAU.

It preferable for the carbon to have no measurable porosity, or at least for its pores to be smaller than the pores of the semipermeable substance.

The object is further achieved by a method in which zeolite membranes having intergranular pores and defects are first produced, and an x-ray amorphous carbon is then introduced into the existing intergranular pores and defects.

Here, the carbon can be deposited in the intergranular pores and defects of a zeolite membrane in various ways.
By synthesis of a zeolite layer on a porous carrier with a high content of an organic template, i.e. a structure-directing substance for synthesizing the desired zeolite structure, and subsequent pyrolysis of the zeolite/template layer under inert conditions at elevated temperature (400-1,000° C.);
By infiltration of a thin zeolite layer with a liquid organic precursor, optionally followed by crosslinking and subsequent pyrolysis of the zeolite/polymer layer under inert conditions at elevated temperature (400-1,000° C.);
By condensation of vaporizable organic substances in the intergranular pores and defects of a zeolite layer and subsequent pyrolysis of the zeolite/polymer layer under inert conditions at elevated temperature (400° C.-1,000° C.);
By direct conversion of a vaporous organic substance into carbon in the intergranular pores and defects of a zeolite layer under inert conditions at elevated temperature (500° C.-1,000° C., chemical vapor deposition (CVD) method).

In this case, the carbon is deposited in the intergranular pores and defects of the zeolite layer in such a manner that the accessibility of the zeolite pores is not hindered. In this manner, membranes of increased selectivity (separation efficiency) and reduced permeance (flow) are produced compared to pure zeolite membranes with their defects. Surprisingly, it was found in this case that in a mixture of water and hydrogen, water passes through the membrane significantly more quickly, while hydrogen permeates only in a very small amount, sometimes below the detectable measurement limit.

The essential advantage of the invention is that in a permeation membrane such as the zeolite membrane, which cannot be produced without defects, these defects are sealed in the follow-up such that substances that would only pass through at these defects are now blocked. In this manner, it is not the defects in a permeation membrane but the effects of such defects in application that are eliminated.

The invention will be described in the following in greater detail by means of examples. The drawings are as follows:

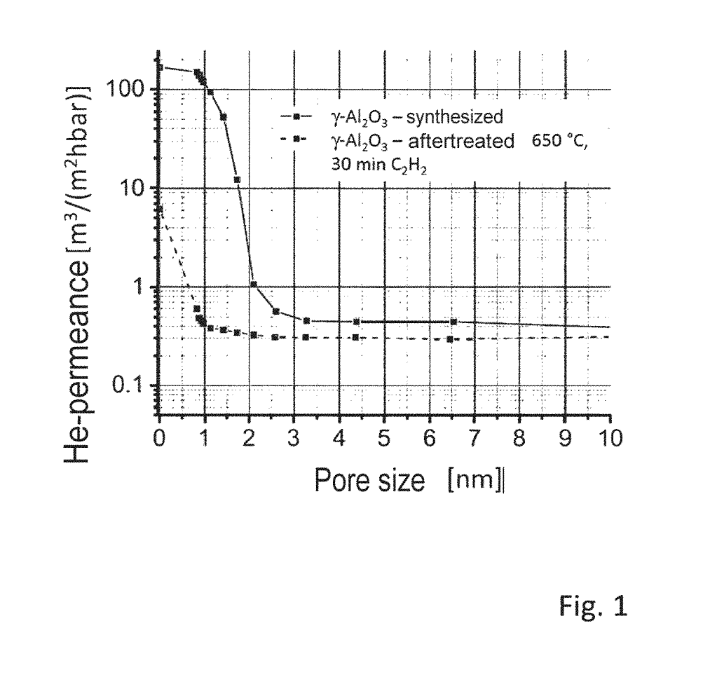

FIG. 1. Permporosimetry tests (He/n-hexane) of the γ-Al₂O₃ membranes in the starting state and in comparison after treatment with acetylene.

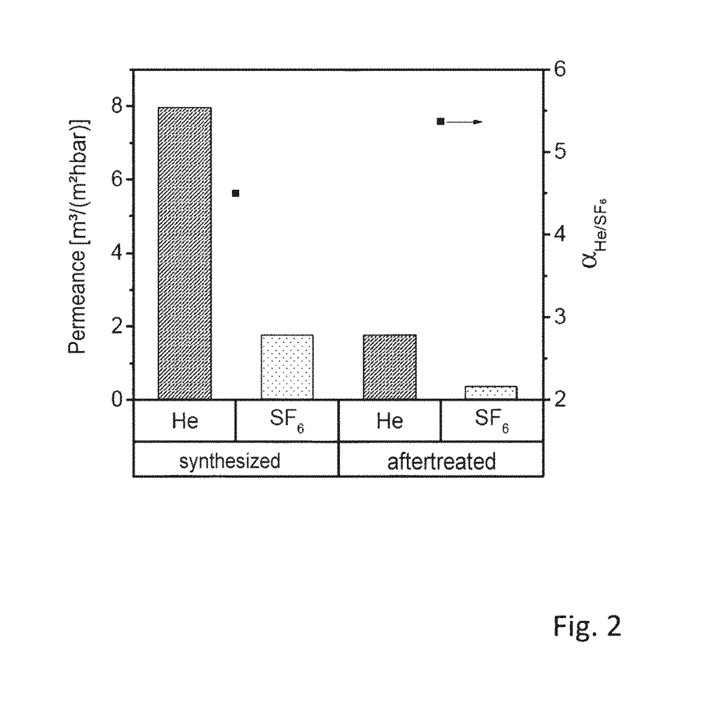

FIG. 2. Individual gas permeances of selected gases on MFI membranes after production (as-prepared) and after treatment with acetylene at 750° C. with a duration of deposition of 45 min (post-treated). The measurement temperature was 150° C.

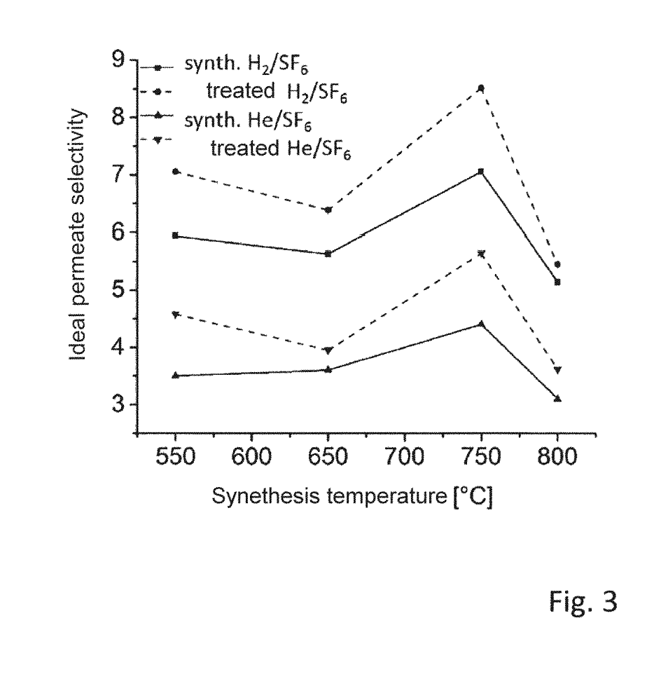

FIG. 3. Ideal permselectivities of H₂/SF₅ and He/SF₅ for MFI membranes calculated from the individual gas permeance measurements.

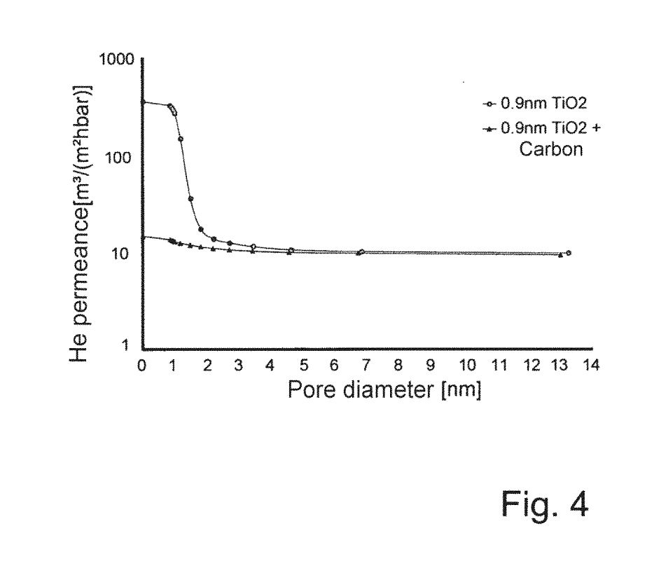

FIG. 4. Permporosimetry measurement of a ceramic membrane with an 0.9 nm pore diameter before and after carbon infiltration by infiltration and pyrolysis of a liquid precursor.

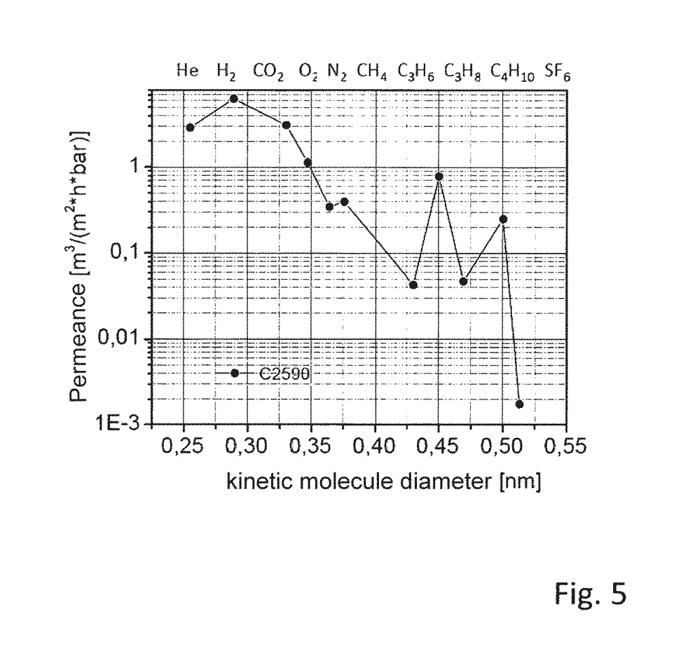

FIG. 5. Individual gas permeance measurement of a carbon-infiltrated zeolite membrane produced by infiltration and pyrolysis of a liquid precursor into a nanozeolite layer.

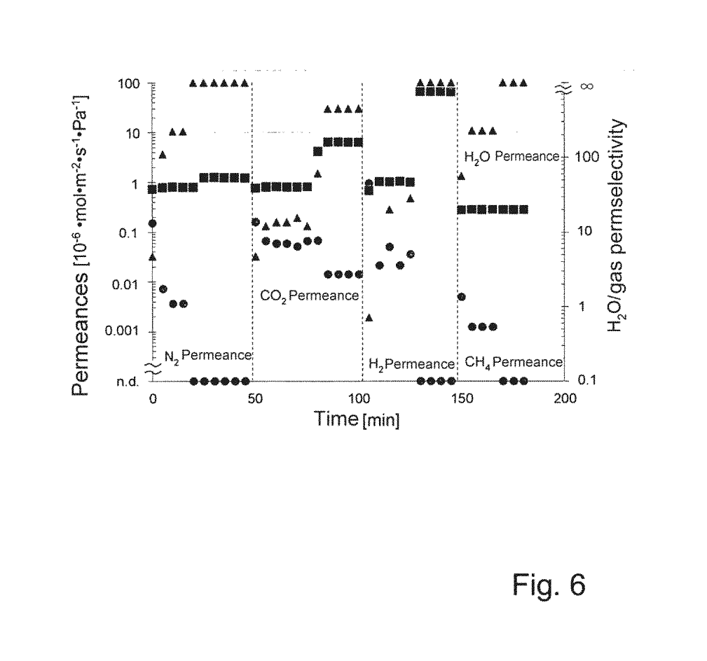

FIG. 6. Permeances in binary 50:50 mixtures of H₂O and N₂, H₂O and CH₄, H₂O and CO₂ as well as H₂O and H₂, and respective H₂O/N₂, H₂O/CH₄, H₂O/CO₂ and H₂O/H₂ permselectivities measured at 200° C., a feed pressure of 11 bar absolute, and a permeation pressure of 1 bar to 4 bar absolute on a carbon-infiltrated zeolite membrane produced by infiltration and pyrolysis of a liquid precursor into a nanozeolite layer (MFI).

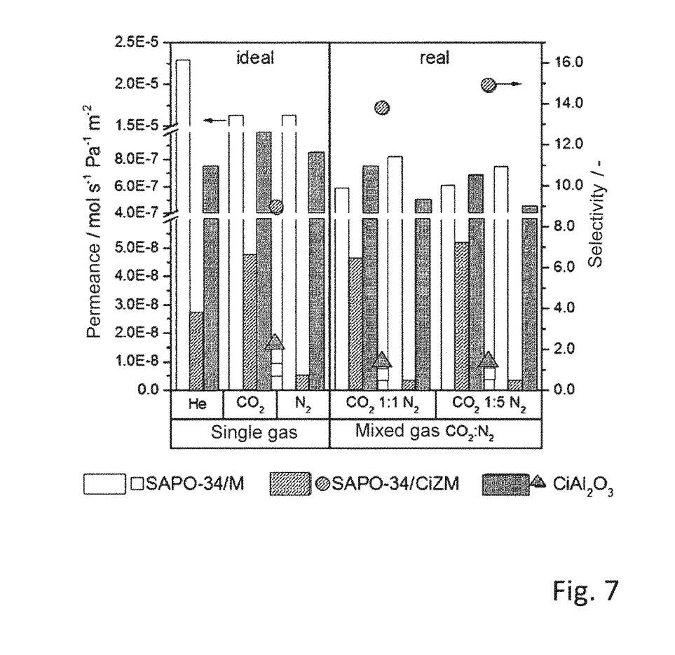

FIG. 7. Permeances of individual gases (He, CO₂ and N₂) and mixed gases (CO₂:N₂ 1:1 and 1:5) and the resulting ideal and real selectivity for separation of the gases CO₂ and N₂ at 25° C. of an SAPO-34 membrane (SAPO-34/M), a carbon-integrated SAPO-34 zeolite membrane (SAPO-34/CiZM, infiltration by immersion) and a carbon-integrated α-Al₂O₃ carrier (CiAl₂O₃); and

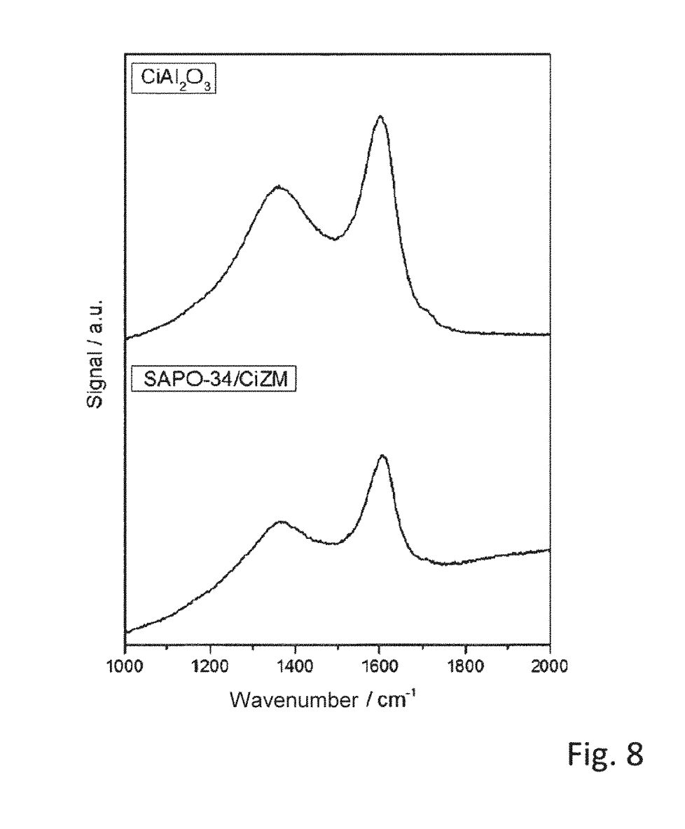

FIG. 8. Raman spectrum of a carbon-integrated α-Al₂O₃ carrier (CiAl₂O₃) and a carbon-integrated SAPO-34 zeolite membrane (SAPO-34/CiZM).

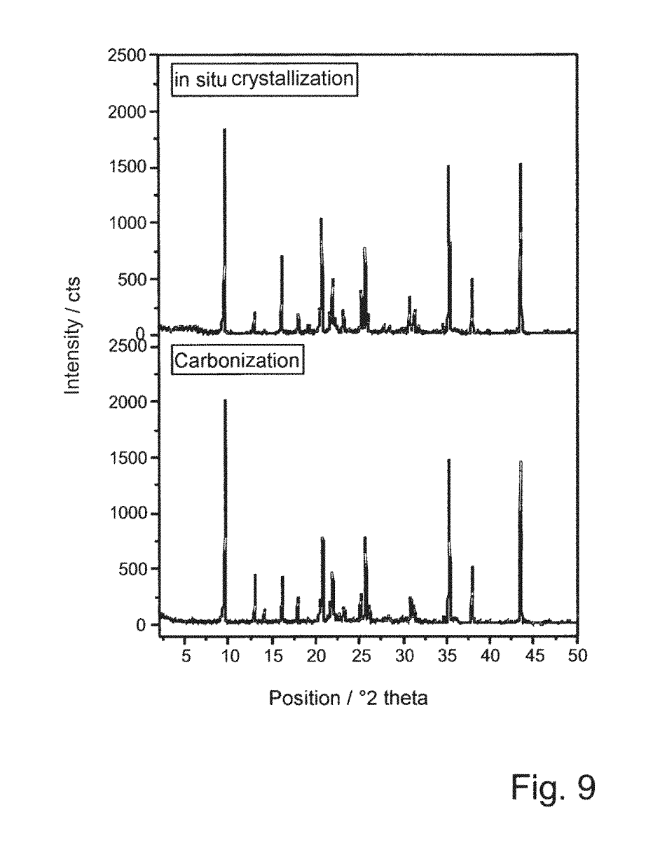

FIG. 9. XRD diffractogram of a SAPO-34 zeolite membrane and a carbon-integrated SAPO-34 zeolite membrane (SAPO-34/CiZM).

As described in the introduction of the description, a zeolite membrane requires a carrier that imparts mechanical stability to the system, but without affecting separation or substance transport. For this reason, the production of various carriers will first be presented, and these will be referred to in the following examples:
1a) A porous ceramic tablet of α-Al₂O₃ with an average pore diameter of 3 μm, a tablet diameter of 18 mm, and a thickness of 2 mm produced by ceramic calendering was progressively coated one side with ceramic slurries of α-Al₂O₃ powders of decreasing particle size by spin coating and subsequent sintering until a final covering layer with an average pore diameter of 200 nm had been applied.
1b) A porous ceramic tube of α-Al₂O₃ with an average pore diameter of 3 μm, an external diameter of 10 mm, an internal diameter of 7 mm, and a length of 100 mm produced by extrusion was progressively coated on the inner side with ceramic slurries of α-Al₂O₃ powders of decreasing particle size by slip casting and subsequent sintering until a final covering layer with an average pore diameter of 100 nm had been applied. A colloidal gel layer was deposited on this covering layer from a colloidal boehmite sol by one-side immersion coating, which after sintering resulted in a final γ-Al₂O₃layer with an average pore diameter of between 2 nm and 5 nm.
1c) A tube according to example 1b), after coating with the 100 nm α-Al₂O₃ layer, was progressively coated with a colloidal TiO₂ sol, a colloidal ZrO₂ sol, and a polymeric TiO₂sol with interspersed thermal treatment of the respective coatings. The final covering layer was composed of amorphous TiO₂ and had an average pore diameter of 0.9 nm.

### WORKING EXAMPLE 1

A membrane from example 1b) was subjected to a deposition process from the gas phase (chemical vapor deposition, CVD) as follows: the membrane was placed in the constant heating zone of a vertical oven. Before the deposition process began, an inert atmosphere was produced by purging with nitrogen. After sufficient purging, the oven containing the membrane and an inert atmosphere was heated to a deposition temperature of 650° C. After this temperature was reached, the gas composition was changed from 100% nitrogen to 96.4% nitrogen (99.8%, Linde) and 3.6% acetylene (99.6%, Air Liquide). The duration of this treatment was 30 min. Following the carbon deposition, the atmosphere was changed to 100% nitrogen and the oven was cooled to room temperature before the sample was removed. Analytical detection was carried out by permporosimetry with He as the permeable phase and n-hexane as the condensed phase (FIG. 1).

It was found that as expected, the starting membrane had a pore diameter of <3 nm. The He dry gas permeance was approx. 180 m³/(m²·h·bar). After blocking of all pores <3 nm, the He permeance decreased to approx. 0.42 m³/(m²·h·bar), which was equivalent to approx. 0.2% of the starting permeance. The remaining permeation corresponded to the gas flow through defects >3 nm. After carbon deposition, the He dry gas permeation decreased by a factor of 30 to approx. 6 m³/(m²·h·bar). With the first 4 n-hexane wetting, the He permeance decreased to approx. 0.4 m³/(m²·h·bar) and then remained largely constant with further wetting. Accordingly, it was already possible by carbon infiltration using the CVD method to reduce pores with a diameter of <3 nm to a diameter of <1 nm. Larger pores, however, were not blocked. The method used for CVD deposition of carbon is therefore suitable for reducing the diameter of pores in the magnitude range of defects and intergranular pores of zeolite membranes.

### WORKING EXAMPLE 2

A porous ceramic tube with a final covering layer of α-Al₂O₃ with an average pore diameter of 100 nm was coated on the inner side of the tube by slip casting with a mixture of silicalite particles, a colloidal silica sol, and water in the mass ratio of 1:4:15. The layer was baked in air at 450° C. After this, hydrothermal treatment was carried out for 24 h at 180° C. in a sealed, Teflon-coated autoclave container in a solution composed of colloidal silica sol, aluminum (Merck), tetrapropylammonium hydroxide (TPAOH 25%, Acros Organics), tetrapropylammonium bromide (>98% TPABr, Alfa Aesar), sodium hydroxide pellets (>99%, VWR) and water (deionized) in the stoichiometric ratio of 90 SiO₂/0.225 Al₂O₃/1 Na₂O/4.15 TPAOH/1.85 TPABr/1990 H₂O. The resulting MFI membrane was detemplated in air at 450° C.

The MFI membrane was subjected according to Working Example 2 to CVD treatment with a 2.4% acetylene nitrogen mixture for a deposition duration of 45 min and a deposition temperature of 750° C. Both the produced and the treated membranes were tested by means of individual gas permeance measurement with selected gases.

It is clear at the individual gas permeances shown in FIG. 2 that by the CVD treatment, the permeances of all of the gases decrease, and the ideal He/SF₆ permselectivity increases from 4.5 to 6.0. This improvement is attributable to controlled blocking of the defect pores or defects.

### WORKING EXAMPLE 3

An MFI membrane according to Working Example 2 was treated with n-hexane (>99%, Merck) as a vapor phase. For this purpose, a nitrogen flow was loaded with n-hexane and guided for 45 min over the membrane, wherein an applied temperature of 550-800° C. was to produce immediate pyrolysis of the condensing n-hexane. For all of the pyrolysis temperatures, it was possible to detect significant increases in the ideal H₂/SF₆and He/SF₆ permselectivities, which is attributable to blocking of the intergranular pores (FIG. 3).

### WORKING EXAMPLE 4

A membrane according to 1c) was infiltrated with a mixture of phenol resin powder (0235DP, Momentive) dissolved in methanol (Merck) and 1-methyl-2-pyrrolidone (Merck) in the mass ratio 3.25:22.5:20 by pouring the mixture into the ceramic tube. After this, thermal treatment was carried out at 150° C. for crosslinking of the phenol resin, followed by pyrolysis under Ar at 740° C. The starting membrane and the carbon-infiltrated membrane were examined by permporosimetry using He as a gas phase and n-hexane as a condensed phase. It was found that as expected, the starting membrane had a pore diameter of <2 nm. The He dry gas permeance was approx. 350 m³/(m²·h·bar). After blocking of all of the pores <2 nm, the He permeance decreased to approx. 12 m³/(m²·h·bar), equivalent to approx. 3% of the starting permeance. The remaining permeation corresponded to the gas flow through defects >2 nm. The permeance through defects >4 nm was approx. 10 m³/(m²·h·bar), and thus 2% of the He dry gas permeance. After carbon deposition, the He dry gas permeance dropped by a factor of 30 to approx. 12 m³/(m²·h·bar). With increasing n-hexane wetting, only a slight decrease in He permeance was observed. For pores >4 nm, the He permeance was identical to that of the membrane without carbon infiltration at 10 m³/(m²·h·bar). Accordingly, it was possible by means of the carbon infiltration to largely block pores with a diameter of <4 nm. Larger pores, on the other hand, were not blocked. The method used of infiltration of a membrane with a liquid precursor and subsequent pyrolysis is therefore suitable for blocking smaller pores that are in the magnitude range of defects and intergranular pores of zeolite membranes.

### WORKING EXAMPLE 5

A tube-shaped ceramic membrane with a final layer of γ-Al₂O₃ with an average pore diameter of between 2 nm and 5 nm according to 1b) was coated with a layer of zeolite nanocrystals produced by hydrothermal synthesis at 60° C. for 14 days in a mixture of TPAOH, TPABr and TEOS (>99%, ABCR) at a molar ratio of 25 SiO₂:9 TPAOH 360 H₂O:100 ethanol according to Person et al., Zeolites, 1994, Vol. 14, September/October, 557-567. Coating was carried out by adhesion of the MFI crystals measuring 50 nm to 60 nm to the porous ceramic substrate using dimethylammonium chloride (65% in water, Fluka) according to Hedlund et al.; J. Membr. Sc. 159 (1999) 263. The zeolite nanolayer obtained in this manner was calcined in air at 450° C. The sample was then infiltrated on one side with phenol resin powder (0235DP, Momentive) dissolved in methanol (Merck) and 1-methyl-2-pyrrolidone (Merck) in the mass ratio of 3.25:22.5:20, followed by polymerization at 150° C. and pyrolysis under Ar at 740° C. The carbon-infiltrated zeolite membrane obtained was tested by individual gas permeation at 150° C. An He permeance of 3 m³/(m²·h·bar), an H₂ permeance of 6 m³/(m²·h·bar), and an SF₆ permeance of approx. 0.002 m³/(m²·h·bar) were observed. With an ideal He/SF₆ permselectivity of approx. 1,650 and an ideal H₂/SF₆ permselectivity of approx. 3,600, a carbon-infiltrated zeolite membrane with molecular sieve properties was obtained (FIG. 5).

Gas mixtures composed to 50% of H₂O and N₂, H₂O and CH₄, H₂O and CO₂ as well as H₂O and H₂ respectively were then directed at 11 bar absolute onto a membrane produced in this manner at 200° C. The pressure on the back side of the membrane was atmospheric pressure (1 bar absolute) or slightly elevated pressure (4 bar absolute). The gas flow passing through the membrane was guided through a cold trap (−10° C.) in which the water produced was condensed. The residual gas flow was measured using a multiscale bubble counting tube. It was found that after switching from one gas mixture to the next, after a brief period, permeation of the gas CO₂ decreased by a factor of about 10 and permeation of the gases N₂, CH₄ and H₂ fell below the detection limit, while water permeation constantly remained in the considerably higher permeation range or even increased. Accordingly, infinitely high H₂O/N₂, H₂O/CH₄, and H₂O/H₂permselectivities, as well as an H₂O/CO₂ permselectivity of 400, were measured. The membrane is therefore permeable to water in any event, but for other gases, it is considerably less permeable to totally impermeable (FIG. 6).

### WORKING EXAMPLE 6

In order to produce a zeolite membrane composed of the active components SAPO-34 and a porous carrier structure, a-aluminum oxide, in situ crystallization is carried out by means of hydrothermal synthesis. For this purpose, a synthesis solution is first produced as follows: The structure-directing agent (SDA), tetraethylammonium hydroxide (TEA-OH, 35 wt %, Sigma Aldrich) is prepared and mixed with the silicon source, tetraethyl orthosilicate (TEOS, 99%, Alfa Aesar) and the additionally required distilled water. This obtained solution A is stirred for 10 min at 600 rpm. Under further stirring at 600 rpm, the aluminum source, aluminum isopropoxide (Al isopropoxide for synthesis, 98%, Merck) is slowly added, and the resulting solution B is stirred for a further 2 h. The phosphorus source, orthophosphoric acid (85 wt %, VWR), is added dropwise to this solution B. The obtained solution C, with a resulting molar composition of 1.0 Al₂O₃:4.0 P₂O₅ 0.6 SiO₂:2.0 TEA-OH 139 H₂O, is aged under stirring at 600 rpm for 30 min. After this, 30 ml of this aged solution C is transferred to a stainless steel autoclave (45 ml, 4744, Parr Instruments) with a Teflon insert, which already contains the α-aluminum oxide carrier to be seeded according to 1a). The subsequent hydrothermal synthesis—in situ crystallization—is carried out statically at 180° C. for 48 h. After the required synthesis time has elapsed, the obtained SAPO-34 membrane (carrier coated during in situ crystallization with SAPO-34) is separated from the resulting excess SAPO-34 powder by centrifugation.

The SAPO-34 membrane synthesized in this manner is first dried at 75° C. and then calcined to remove the template. During the calcination process, the SAPO-34 membrane is heated in air at a heating rate of 0.2 K min⁻¹ to 400° C., exposed to this temperature for 16 h, and then slowly cooled. The SAPO-34 membrane produced is stored in an oven heated to 100° C.

### WORKING EXAMPLE 7

Starting from a zeolite membrane, a carbon-integrated membrane is produced by two method steps:
1. liquid infiltration of the zeolite membrane
2. carbonization of the infiltrated zeolite membrane

For infiltration of the produced SAPO-34 membrane, a solution of the monomer furfuryl alcohol (≥98.0%, Merck) and nitric acid (HNO₃, 65 wt %, Fluka) is first produced. For this purpose, the furfuryl alcohol is prepared, and the required amount of nitric acid is then added dropwise under stirring. Under further stirring, prepolymerization of this solution takes place for 40 min. After this, the produced SAPO-34 membrane is immersed for 5 min in this solution. The infiltrated SAPO-34 membranes are first dried for crosslinking of the polymers for 16 h at 75° C. and then carbonized. The carbonization takes place in a nitrogen atmosphere at 500° C. for 16 h. The heating rate in this case is also 0.2 K min⁻¹.

### WORKING EXAMPLE 8

As a system for comparison with the produced carbon-integrated zeolite membranes, starting from an α-Al₂O₃ carrier with a pore size of 200 nm according to 1a), a carbon-integrated α-Al₂O₃ carrier (CiAl₂O₃) was produced. As in the case of Working Example 7, the α-Al₂O₃ carrier is immersed in a prepolymerized solution of furfuryl alcohol and nitric acid, dried, and then carbonized. The produced SAPO-34 membrane (SAPO-34/M, Working Example 6), the carbon-integrated SAPO-34 membranes (SAPO-34/CiZM, Working Example 7), and the carbon-integrated α-Al₂O₃ carrier (CiAl₂O₃, Working Example 8) are characterized at different temperatures (25° C.) by means of permeance measurements of individual gases and mixed gases (FIG. 7), and selectivities for the separation of CO₂ and N₂ are determined from this.

The pure SAPO-34 membrane showed extremely high permeances in the magnitude range around 2×10⁻⁵ mol/(m²·s·Pa) (individual gas permeation) or around 7×10⁻⁷ mol/(m²·s·Pa) (mixed gas permeation). With permselectivities of about 1, there was virtually no selective substance separation. The integration of carbon caused the permeances to decrease to values of 0.5×10⁻⁸ mol/(m²·s·Pa) (N₂) to 5×10⁻⁸ mol/(m²·s·Pa) (CO₂), and the permselectivities increased to 9 (ideal permselectivity of the individual gas measurement) or to 14 or 15 (mixed gas measurements), which corresponds to a membrane with highly selective separation. An α-Al₂O₃ membrane integrated with carbon having a pore diameter of 200 nm, on the other hand, showed selectivities of only 1 to 2. Accordingly, the separation properties of the carbon-integrated zeolite membrane are the separation properties of the zeolite crystals, the intergranular pores of which were blocked by carbon.

The carbon species produced were further tested by Raman spectroscopy. The Raman spectra of the two samples (in the infiltrated α-Al₂O₃ carrier with 200 nm pores and in intergranular pores of the infiltrated zeolite membrane) show the bands typical for carbon at approx. 1350 cm⁻¹ and approx. 1590 cm⁻¹. The band at 1590 cm⁻¹ represents the stretching vibration sp² of hybridized carbon bonds in the plane. In amorphous structures, in addition to these bands, one can see a further band at 1350 cm⁻¹ that shows a different symmetry. The Raman spectra indicate an amorphous structure of carbon (FIG. 8).

A pure zeolite membrane on an α-Al₂O₃ carrier with 200 nm pores (SAPO-34/M) and a zeolite membrane subsequently treated with carbon (SAPO-34(CiZM) were examined by x-ray diffractometry (FIG. 9). In both diffractograms, only the characteristic x-ray reflexes of the zeolite and the α-Al₂O₃ carrier ceramic could be found. The carbon could not be detected as a crystalline species. Accordingly, the infiltrated carbon is x-ray amorphous carbon.

1.-9. (canceled)

10. A permeation membrane, wherein the permeation membrane is composed of an inorganic, semipermeable substance into which a further substance is incorporated at certain points such that existing intermediate spaces in the semipermeable substance are at least partially filled by the further substance and thus only intermediate spaces are blocked for a permeating species such that small gas molecules can be separated from one another in a mixture according to their size.

11. The permeation membrane of claim 10, wherein the permeation membrane is capable of separating water from hydrogen.

12. The permeation membrane of claim 10, wherein the permeation membrane is capable of separating water from nitrogen.

13. The permeation membrane of claim 10, wherein the permeation membrane is capable of separating water from methane.

14. The permeation membrane of claim 10, wherein the permeation membrane is capable of separating water from carbon dioxide.

15. The permeation membrane of claim 10, wherein the further substance comprises an x-ray amorphous carbon.

16. The permeation membrane of claim 10, wherein the semipermeable substance is a crystalline substance with a zeolite structure.

17. The permeation membrane of claim 15, wherein the semipermeable substance is a crystalline substance with a zeolite structure.

18. The permeation membrane of claim 10, wherein the semipermeable substance is selected from aluminosilicates and aluminophosphates.

19. The permeation membrane of claim 10, wherein the semipermeable substance is selected from silicon aluminophosphates.

20. The permeation membrane of claim 10, wherein the semipermeable substance is selected from metal-organic frameworks.

21. The permeation membrane of claim 16, wherein the crystalline substance with a zeolite structure is a representative of the structures SOD, LTA, ERI, CHA, MFI, FAU.

22. The permeation membrane of claim 15, wherein the carbon has no measurable porosity.

23. The permeation membrane of claim 15, wherein the carbon has pores smaller than those of the semipermeable substance.

24. A method for producing a permeation membrane, wherein the method comprises:
a) production of a zeolite membrane having intergranular pores and defects,
b) incorporation of an x-ray amorphous carbon into the intergranular pores and defects of the zeolite membrane.

25. The method of claim 24, wherein the incorporation of the carbon into the intergranular pores and defects of the zeolite membrane is carried out by infiltration of an organic precursor and subsequent pyrolysis under inert conditions.

26. The method of claim 24, wherein the incorporation of the carbon into the intergranular pores and defects of the zeolite membrane is carried out by condensation of a vaporous, organic precursor and subsequent pyrolysis under inert conditions.

27. The method of claim 24, wherein the incorporation of the carbon into the intergranular pores and defects of the zeolite membrane is carried out by reactive deposition of a vaporized organic species from a gas phase (chemical vapor deposition).

28. The method of claim 24, wherein the incorporation of the carbon into the intergranular pores and defects of the zeolite membrane is carried out by pyrolysis of excess template.

29. A method for separating water from mixtures of water with one or more of hydrogen, nitrogen, methane or carbon dioxide, wherein the method comprises contacting the mixture with the permeation membrane of claim 10.
